(19) United States
(12) Patent Application Publication
(10) Pub. No.: US 2017/0034568 A1
(43) Pub. Date: Feb. 2, 2017

(54) VIDEO AUDIO PROCESSING DEVICE, VIDEO AUDIO PROCESSING METHOD, AND PROGRAM

(71) Applicant: Panasonic Intellectual Property Management Co., Ltd., Osaka (JP)

(72) Inventors: TATSUYA SUZUKI, Osaka (JP); YOSHIYUKI SASAGAWA, Osaka (JP); TATSUTO HORIBE, Osaka (JP); SHUNSUKE TANAKA, Osaka (JP)

(21) Appl. No.: 15/303,774

(22) PCT Filed: Sep. 16, 2015
(86) PCT No.: PCT/JP2015/004718

§ 371 Date: Oct. 13, 2016

(30) Foreign Application Priority Data
Sep. 19, 2014 (JP) 2014-190783

(51) Int. Cl. H04N 21/439; H04N 21/44; H04N 21/485

(52) U.S. Cl. CPC H04N 21/439; H04N 21/4852; H04N 21/44008

(57) ABSTRACT

A video/audio processing apparatus includes a video generator, a selector, and a volume controller. The video generator generates a video signal for display video in which a plurality of regions, in each of which a moving image is displayed, automatically move in a display screen in a predetermined direction. The selector selects an audio signal of one moving image, of a plurality of the moving images, in accordance with positions of a plurality of the moving images in the display screen. The volume controller controls volumes of audio signals of a plurality of the moving images so that a volume of the audio signal selected by the selector is higher than volumes of other audio signals.

### TECHNICAL FIELD

The present disclosure relates to a video/audio processing apparatus and video/audio processing method for generating video in which a plurality of moving images are displayed on one display screen.

### BACKGROUND ART

Patent Literature 1 discloses an information processing apparatus employing a technology of displaying a plurality of moving images on one display screen. The information processing apparatus determines audio output coordinates of each program so as to interlock them with a scrolling operation of program display, and synthesizes the audios of each program on the basis of the audio output coordinates.

### CITATION LIST

### Patent Literature

PTL 1: Unexamined Japanese Patent Publication No. 2003-87681

### SUMMARY

It is desirable that a video/audio processing apparatus for generating video in which a plurality of moving images are displayed on one display screen can generate an audio easily heard by a user.

The present disclosure provides a video/audio processing apparatus and video/audio processing method capable of generating an audio easily heard by a user.

The video/audio processing apparatus of the present disclosure includes a video generator, a selector, and a volume controller. The video generator generates a video signal for display video in which a plurality of regions, in each of which a moving image is displayed, automatically move in a display screen in a predetermined direction. The selector selects an audio signal of one moving image, of a plurality of the moving images, in accordance with positions of a plurality of the moving images in the display screen. The volume controller controls volume of each of the audio signal of a plurality of the moving images so that a volume of the audio signal selected by the selector is higher than volumes of other audio signals.

The video/audio processing apparatus of the present disclosure can generate an audio easily heard by a user when a plurality of moving images are displayed in one display screen.

### BRIEF DESCRIPTION OF DRAWINGS

FIG. 1 is a block diagram showing one configuration example of a video/audio processing apparatus in accordance with a first exemplary embodiment.

FIG. 2 is a diagram schematically showing one example of the display video generated by the video/audio processing apparatus in accordance with the first exemplary embodiment.

FIG. 3 is a diagram schematically showing the summary of audio control processing executed by the video/audio processing apparatus in accordance with the first exemplary embodiment.

FIG. 4 is a diagram schematically showing one example of the operation of the video/audio processing apparatus when two moving images are included in a audio output region in accordance with the first exemplary embodiment.

FIG. 5 is a diagram schematically showing one example of the time variation in the volume of each moving image when two moving images are included in the audio output region in accordance with the first exemplary embodiment.

FIG. 6 is a flowchart showing one example of the video/audio generation processing executed by the video/audio processing apparatus in accordance with the first exemplary embodiment.

FIG. 7 is a flowchart showing one example of the initial volume setting processing in accordance with the first exemplary embodiment.

FIG. 8 is a diagram schematically showing one example of the time variation in the volume of a moving image included in an audio output region in accordance with modified example 1 of another exemplary embodiment.

FIG. 9 is a diagram schematically showing one example of the operation of a video/audio processing apparatus when two moving images are included in an audio output region in accordance with modified example 2 of another exemplary embodiment.

FIG. 10 is a diagram schematically showing one example of the time variation in the volume of each moving image when two moving images are included in the audio output region in accordance with modified example 2 of another exemplary embodiment.

FIG. 11 is a flowchart showing one example of the video/audio generation processing executed by the video/audio processing apparatus in accordance with modified example 2 of another exemplary embodiment.

FIG. 12 is a diagram schematically showing the summary of audio control processing in accordance with modified example 3 of another exemplary embodiment.

FIG. 13 is a flowchart showing one example of the video/audio generation processing executed by a video/audio processing apparatus in accordance with modified example 3 of another exemplary embodiment.

FIG. 14 is a block diagram showing one configuration example of a video/audio processing apparatus in accordance with modified example 4 of another exemplary embodiment.

FIG. 15 is a diagram schematically showing one example of display video in accordance with modified example 4 of another exemplary embodiment.

### DESCRIPTION OF EMBODIMENTS

Hereinafter, the exemplary embodiments will be described in detail appropriately with reference to the accompanying drawings. Description more detailed than necessary is sometimes omitted. For example, a detailed description of a well-known item and a repeated description of substantially the same configuration are sometimes omitted. This is for the purpose of preventing the following descriptions from becoming more redundant than necessary and allowing persons skilled in the art to easily understand the exemplary embodiments.

The accompanying drawings and the following descriptions are provided to allow the persons skilled in the art to sufficiently understand the present disclosure. It is not intended that they restrict the main subject described within the scope of the claims.

Each diagram is a schematic diagram, and is not always exact. In each diagram, the same components are denoted with the same reference marks.

### First Exemplary Embodiment

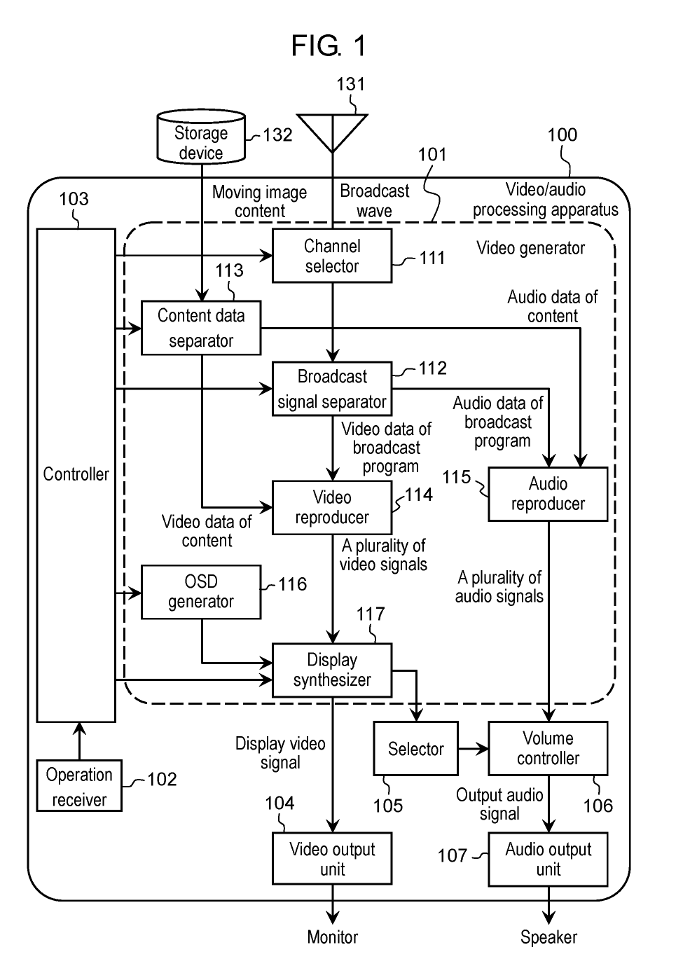

The first exemplary embodiment is hereinafter described using FIG. 1 to FIG. 15.

First, the configuration of video/audio processing apparatus 100 is described.

[1-1. Configuration of Video/Audio Processing Apparatus]

FIG. 1 is a block diagram showing one configuration example of video/audio processing apparatus 100 in accordance with the first exemplary embodiment.

Video/audio processing apparatus 100 shown in FIG. 1 generates a video signal showing that a plurality of moving images are displayed in one display screen. For example, video/audio processing apparatus 100 is mounted on a television, a recorder, a personal computer, a mobile terminal, or a smartphone.

Video/audio processing apparatus 100 includes video generator 101, operation receiver 102, controller 103, video output unit 104, selector 105, volume controller 106, and audio output unit 107.

Video generator 101 generates and outputs a video signal (hereinafter referred to as “display video signal”) for display video in which a region having a plurality of moving images automatically moves (hereinafter referred to as “scrolls”) in the display screen in a predetermined direction. Video generator 101 also outputs audio signals of a plurality of audios corresponding to a plurality of the moving images.

Video generator 101 includes channel selector 111, broadcast signal separator 112, content data separator 113, video reproducer 114, audio reproducer 115, on screen display (OSD) generator 116, and display synthesizer 117.

Channel selector 111 selects a signal of a broadcast program as a reproducing object from a plurality of broadcast signals received by antenna 131, and outputs the selected signal of the broadcast program to broadcast signal separator 112. Channel selector 111 outputs transport stream (TS), for example, to broadcast signal separator 112.

Broadcast signal separator 112 extracts video data and audio data from the TS output from channel selector 111, outputs the video data to video reproducer 114, and outputs the audio data to audio reproducer 115.

Content data separator 113 acquires a moving image content from storage device 132, outputs the video data of the acquired moving image content to video reproducer 114, and outputs the audio data thereof to audio reproducer 115. Storage device 132 is a mass storage device such as a hard disk drive (HDD), for example. Storage device 132 accumulates a plurality of moving image contents, and outputs a moving image content selected by a user.

Video reproducer 114 individually reproduces the video data of the broadcast program output from broadcast signal separator 112 and the video data of the moving image content output from content data separator 113, generates a plurality of video signals, and outputs a plurality of the generated video signals to display synthesizer 117.

Audio reproducer 115 individually reproduces the audio data of the broadcast program output from broadcast signal separator 112 and the audio data of the moving image content output from content data separator 113, generates a plurality of audio signals, and outputs a plurality of the generated audio signals to volume controller 106.

The present exemplary embodiment shows a configuration example in which video/audio processing apparatus 100 is configured to reproduce both of the moving image content and broadcast program. However, the present disclosure is not limited to this configuration. Video/audio processing apparatus 100 may be configured to reproduce only one of the moving image content and broadcast program. When video/audio processing apparatus 100 has such a configuration, video reproducer 114 and audio reproducer 115 reproduce only either a plurality of moving image contents or a plurality of broadcast programs. In video/audio processing apparatus 100 shown in FIG. 1, video reproducer 114 and audio reproducer 115 may reproduce only either a plurality of moving image contents or a plurality of broadcast programs.

FIG. 1 shows a configuration example in which both of antenna 131 and storage device 132 are installed outside video/audio processing apparatus 100. However, the present disclosure is not limited to this configuration. At least one of antenna 131 and storage device 132 may be included in video/audio processing apparatus 100. Video/audio processing apparatus 100 may be configured to hold moving image contents by itself and reproduce the held moving image contents. Alternatively, video/audio processing apparatus 100 may be configured to acquire, via the Internet or the like, moving image contents accumulated in a moving image server or the like.

OSD generator 116 generates an OSD video signal for displaying OSD video on the display screen.

Display synthesizer 117 generates a display video signal by synthesizing a plurality of the video signals reproduced by video reproducer 114 and the OSD video signal, and outputs the generated display video signal. The generated display video signal is a video signal for displaying the display video including a plurality of moving images on the display screen. Thus, display synthesizer 117 generates the display video signal in which a plurality of the video signals reproduced by video reproducer 114 is overlaid on each other.

Operation receiver 102 receives a user operation. The user operation includes a direct operation by the user to video/audio processing apparatus 100, or a remote operation to video/audio processing apparatus 100 using a remote controller (not shown), for example.

Controller 103 controls video generator 101 in response to a user operation or the like received by operation receiver 102. For example, controller 103 performs the processes of: specifying a broadcast signal to be selected by channel selector 111; specifying a moving image content to be acquired by content data separator 113; specifying a broadcast program to be processed by broadcast signal separator 112; commanding OSD generator 116 to generate an OSD video signal; and commanding display synthesizer 117 to generate a display video signal.

Video output unit 104 outputs, to a display unit such as a monitor, the display video signal generated by display synthesizer 117. FIG. 1 shows a configuration example in which the monitor is installed outside video/audio processing apparatus 100. However, the present disclosure is not limited to this configuration. Video/audio processing apparatus 100 may be configured to include a display unit and display the display video on the display unit.

Selector 105, on the basis of the display video signal output from display synthesizer 117, selects one audio signal from a plurality of the audio signals output from audio reproducer 115. In other words, selector 105 selects the audio signal of one moving image, of a plurality of the moving images, in accordance with the positions of a plurality of the moving images in the display screen. Hereinafter, the audio signal is simply referred to as “audio”.

Volume controller 106 generates an output audio signal by controlling the volumes of a plurality of the audio signals output from audio reproducer 115, and outputs the generated output audio signal to audio output unit 107. At this time, volume controller 106 controls the volumes of the audio signals for a plurality of the moving images so that the volume of the audio signal selected by selector 105 is higher than those of the other audio signals.

Audio output unit 107 outputs the output audio signal generated by volume controller 106 to a speaker. FIG. 1 shows a configuration example in which the speaker is installed outside video/audio processing apparatus 100. However, the present disclosure is not limited to this configuration. Video/audio processing apparatus 100 may be configured to include a speaker and output an audio from the speaker.

Next, the display video generated by video/audio processing apparatus 100 is described.

[1-2. Display Video]

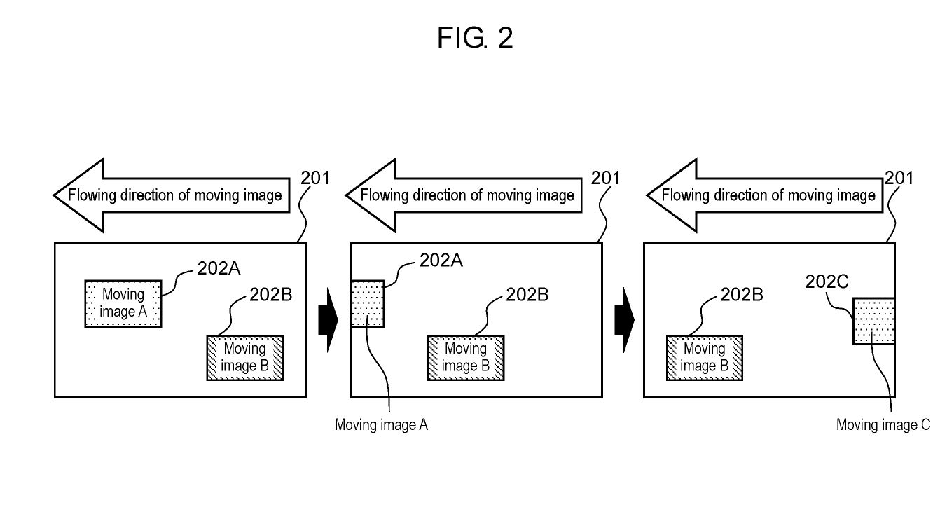

FIG. 2 is a diagram schematically showing one example of the display video generated by video/audio processing apparatus 100 in accordance with the first exemplary embodiment.

FIG. 2 shows an example of displaying, on screen 201, the video in which moving image 202A, moving image 202B, and moving image 202C move from the right to the left of screen 201 as time passes. Here, moving images 202A to 202C correspond to a plurality of video signals generated by video reproducer 114. Each of moving images 202A to 202C is, for example, a broadcast program, a moving image content recorded or shot by a user, or a moving image content acquired from an external moving image server or the like via the Internet or the like.

As shown in FIG. 2, in the display video generated by video/audio processing apparatus 100, an image including a plurality of moving images (for example, moving images 202A to 202C) automatically scrolls from the right to the left of screen 201. Thus, a plurality of the moving images is sequentially displayed on screen 201.

Although not shown, other information may be displayed outside the display region of the moving images on screen 201. Other information may be a still image, text information, a menu, an icon, or link information (for example, uniform resource locator (URL)), for example.

FIG. 2 shows an example in which three moving images 202A to 202C are displayed on screen 201. However, the number of moving images displayed on screen 201 may be two or less, or four or more. The sizes of the moving images displayed on screen 201 may be the same, or may be different from each other. The arrangement positions of moving images 202A to 202C on screen 201 shown in FIG. 2 are simply one example, and the moving images are appropriately arranged.

FIG. 2 shows the example in which, in the display video generated by video/audio processing apparatus 100, an image including a plurality of moving images (for example, moving images 202A to 202C) scroll from the right to the left of screen 201. However, the present disclosure does not restrict the direction of the scroll. The images may scroll from the left to the right of screen 201, or may scroll from the top to the bottom or from the bottom to the top of screen 201. Alternatively, the images may scroll in an oblique direction. FIG. 2 shows the operation example in which the images scroll linearly. However, the images may scroll while drawing a predetermined locus such as a waveform.

In the display video generated by video/audio processing apparatus 100, the whole screen may scroll, or only some region in the screen that includes a plurality of moving images may scroll.

For example, in the case that a user operation is not performed for a certain time, video/audio processing apparatus 100 may start an operation in which moving images automatically scroll in the display video as shown in FIG. 2. Hereinafter, this operation is also referred to as “automatic scroll operation”. When a user operation is performed during the automatic scroll operation, video/audio processing apparatus 100 may cancel the automatic scroll operation. Alternatively, upon receiving a predetermined user operation, video/audio processing apparatus 100 may start or cancel the automatic scroll operation.

Next, the audio control processing performed in video/audio processing apparatus 100 is described.

[1-3. Audio Control Processing]

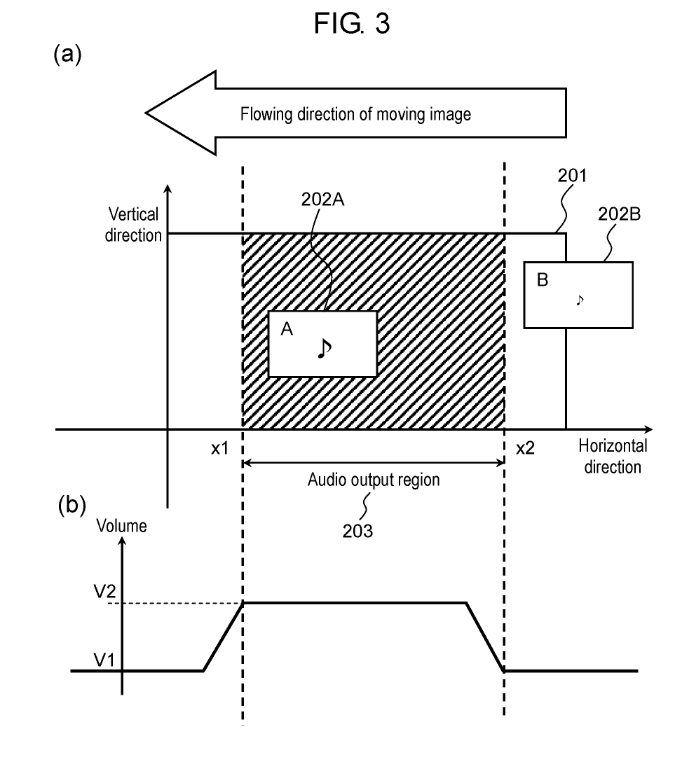

FIG. 3 is a diagram schematically showing the summary of audio control processing executed by video/audio processing apparatus 100 in accordance with the first exemplary embodiment. FIG. 3 (a) is a diagram schematically showing the state in which moving image 202A and a part of moving image 202B are displayed on screen 201. FIG. 3 (a) schematically shows the display region of screen 201, the horizontal axis shows the horizontal direction (longitudinal direction) of screen 201, and the vertical axis shows the vertical direction (lateral direction) of screen 201. In the example shown in FIG. 3 (a), about one third of moving image 202B is displayed in screen 201, and about two thirds thereof exists outside screen 201. This example shows that moving image 202B gradually moves leftward by scroll and the area displayed in screen 201 gradually increases. FIG. 3 (b) is a diagram schematically showing the volume of the moving image included in a audio output region. The vertical axis of FIG. 3 (b) shows the level of the volume.

Video/audio processing apparatus 100 includes audio output region 203 in screen 201 as shown in FIG. 3. Audio output region 203 means the region from position X1 to position X2 shown in FIG. 3 (a), and the region from which video/audio processing apparatus 100 outputs the audio of a moving image. In the example of FIG. 3, audio output region 203 is set near the center of screen 201 in video/audio processing apparatus 100. However, the present disclosure does not restrict audio output region 203 to the range shown in FIG. 3. For example, audio output region 203 may be set so as to cover the whole of screen 201.

In the example shown in FIG. 3, moving image 202A and a part of moving image 202B are displayed on screen 201, moving image 202A is included in audio output region 203, and moving image 202B is not included in audio output region 203. In this example, video/audio processing apparatus 100 selects moving image 202A included in audio output region 203 as a moving image (hereinafter referred to as “target moving image”) whose audio is to be output. The volume (hereinafter referred to as “volume V2”) of the audio of the target moving image is set higher than the volume (hereinafter referred to as “volume V1”) of the audios of moving images other than the target moving image. Volume V1 may be 0 (zero). In other words, video/audio processing apparatus 100 may operate so that it outputs only the audio of the target moving image and does not output the audios of the moving images other than the target moving image.

As shown in FIG. 3, when a moving image is included in audio output region 203 and becomes a target moving image, video/audio processing apparatus 100 gradually increases the volume of the moving image from volume V1 to volume V2. When the target moving image moves out of audio output region 203 and becomes a non-target moving image, video/audio processing apparatus 100 gradually decreases the volume of the moving image from volume V2 to return it to volume V1. Preferably, the period in which the volume of the target moving image increases from volume V1 to volume V2 and the period in which the volume decreases from volume V2 to volume V1 are set individually and appropriately so that the user does not feel uncomfortable.

The graph of the volume shown in FIG. 3 shows a gain by which volume controller 106 multiplies an original audio signal.

Hereinafter, the operation example is described in which the position used for determination in the moving image is set at the left end of the moving image. In other words, when the left end of the moving image is included in audio output region 203, selector 105 of video/audio processing apparatus 100 determines that the moving image is included in audio output region 203. When the left end of the moving image moves out of audio output region 203, selector 105 determines that the moving image is no longer included in audio output region 203. However, the position of the moving image used for determination is not limited to the left end of the moving image. For example, the center of the moving image may be used for determination, or the right end of the moving image may be used for determination. Alternatively, another position may be used for determination.

Hereinafter, the operation example when two moving images 202A and 202B are included in audio output region 203 is described. Hereinafter, the operation example in which volume V1 is set at 0 (zero) is described. Also when three or more moving images are included in audio output region 203, processing similar to that in the following description can be employed. Volume V1 is not limited to 0, but may be another numerical value.

When two moving images are simultaneously included in audio output region 203, video/audio processing apparatus 100 outputs the audio of the moving image that is included in audio output region 203 ahead. Furthermore, when the moving image whose audio is being output moves out of audio output region 203 and is no longer included in audio output region 203, video/audio processing apparatus 100 switches the moving image whose audio is to be output from the former moving image to the moving image that is included in audio output region 203 later.

In other words, when a plurality of moving images is included in audio output region 203, selector 105 selects the audio signal of the moving image that is included in audio output region 203 first, of a plurality of the moving images. Furthermore, when the moving image corresponding to the audio signal selected until then moves out of audio output region 203 to become a non-target of the selection, selector 105 selects the audio signal of the moving image that is included in audio output region 203 first, of a plurality of the moving images included in audio output region 203 at this time.

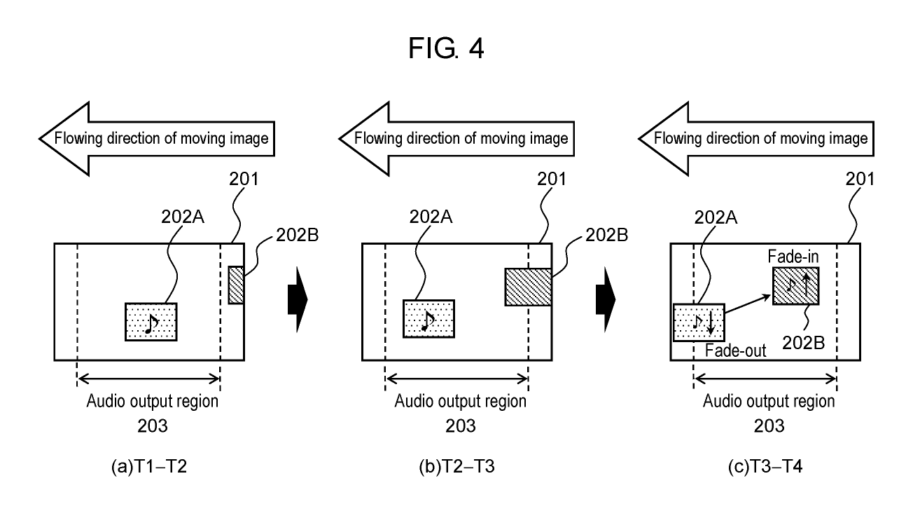

FIG. 4 is a diagram schematically showing one example of the operation of video/audio processing apparatus 100 when two moving images (moving image 202A and moving image 202B) are included in audio output region 203 in accordance with the first exemplary embodiment. FIG. 4 schematically shows display video of screen 201, and the display audio changes in the sequence of (a), (b), and (c) as time passes. In FIG. 4, the scroll direction of the moving images is shown by a hollow arrow. FIG. 4 shows the following operation example:
first, moving image 202A is included in audio output region 203;
moving image 202B (left end of moving image 202B) is included in audio output region 203 before moving image 202A (left end of moving image 202A) moves out of audio output region 203; and
then, moving image 202A (left end of moving image 202A) moves out of audio output region 203 and is no longer included in audio output region 203.
   Here, the hollow arrow indicating the scroll direction of FIG. 4 is shown for convenience, and is not displayed on screen 201.

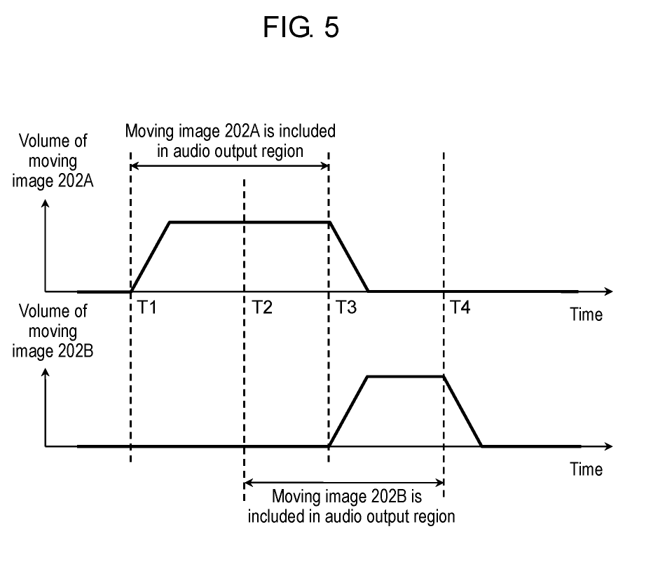

FIG. 5 is a diagram schematically showing one example of the time variation in the volume of each moving image when two moving images (moving image 202A and moving image 202B) are included in audio output region 203 in accordance with the first exemplary embodiment.

FIG. 4 (a) shows the state in the period from time T1 to time T2 of FIG. 5.

In FIG. 4 and FIG. 5, the following states are assumed:
at time T1, moving image 202A (left end of moving image 202A) is included in audio output region 203;
at time T2, moving image 202B (left end of moving image 202B) is included in audio output region 203; and
at time T3, moving image 202A (left end of moving image 202A) moves out of audio output region 203 and is no longer included in audio output region 203.
   Therefore, in the period from time T1 to time T2, moving image 202A is included in audio output region 203, and moving image 202B exists outside audio output region 203 and is not included in audio output region 203. In this case, video/audio processing apparatus 100 outputs the audio of moving image 202A.

Next, FIG. 4 (b) shows the state in the period from time T2 to time T3 of FIG. 5. In the period from time T2 to time T3, moving image 202A is included in audio output region 203, so that video/audio processing apparatus 100 continuously outputs the audio of moving image 202A, and does not output the audio of moving image 202B.

Next, FIG. 4 (c) shows the state after time T3 of FIG. 5. At time T3, moving image 202A moves out of audio output region 203 and is no longer included in audio output region 203. Therefore, at time T3, video/audio processing apparatus 100 switches the moving image whose audio is to be output from moving image 202A to moving image 202B. At this time, volume controller 106 of video/audio processing apparatus 100 gradually decreases (fades out) the audio of moving image 202A, and gradually increases (fades in) the audio of moving image 202B.

In other words, when selector 105 switches the audio to be selected from one audio to another audio, volume controller 106 gradually decreases the volume of the deselected audio, and gradually increases the volume of the newly selected audio.

Next, the video/audio generation processing is described.

[1-4. Flow of Video/Audio Generation Processing]

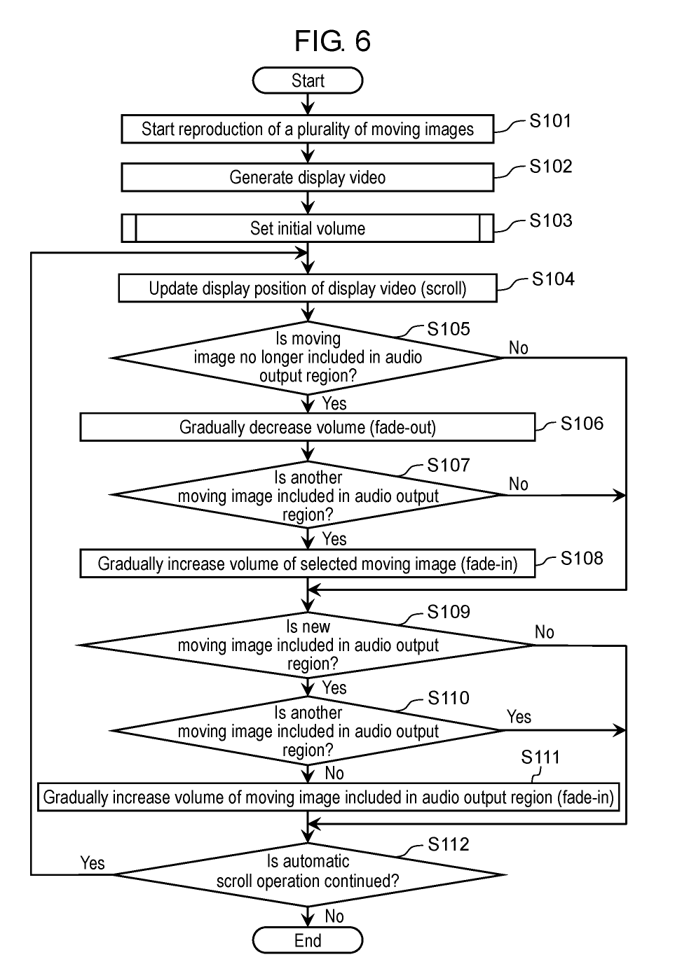

FIG. 6 is a flowchart showing one example of the video/audio generation processing executed by video/audio processing apparatus 100 in accordance with the first exemplary embodiment.

First, video reproducer 114 starts the reproduction of video data of a plurality of moving image contents, and audio reproducer 115 starts the reproduction of audio data of a plurality of the moving image contents (step S101).

Next, display synthesizer 117 generates display video including a plurality of the moving images reproduced in step S101 (step S102). The display video generated in step S102 may include OSD video, for example.

Next, selector 105 and volume controller 106 perform initial volume setting processing (step S103). At the time when step S103 is executed, the image scroll has not been started in the display video.

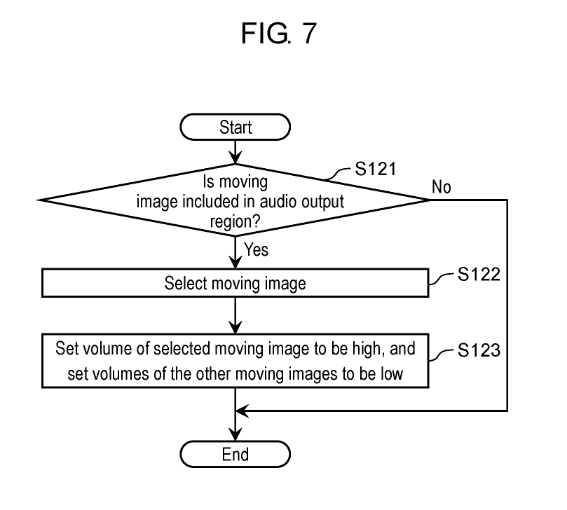

Then, the initial volume setting processing in step S103 is described using FIG. 7.

FIG. 7 is a flowchart showing one example of the initial volume setting processing in accordance with the first exemplary embodiment.

First, selector 105 determines whether a moving image exists in audio output region 203 (step S121).

If it is determined in step S121 that a moving image does not exist in audio output region 203 (No in step S121), selector 105 does not select the audio of any moving image, and volume controller 106 does not output the audio of any moving image.

Here, this operation is an operation performed when volume V1 is set at 0. When volume V1 is not 0, volume controller 106 controls the volume of the audio of the moving image outside audio output region 203 (namely, the audio that has not been selected by selector 105) to a preset volume V1.

If it is determined in step S121 that a moving image exists in audio output region 203 (Yes in step S121), selector 105 selects the audio of the moving image included in output region 203 (step S122). When a plurality of moving images are included in output region 203, selector 105 selects the audio of the moving image that is determined to be included in audio output region 203 first, of a plurality of the moving images, on the basis of the scroll direction of the display video. In the example shown in FIG. 4, selector 105 selects the audio of the moving image located on the leftmost side.

Next, volume controller 106 sets the volume of the audio selected by selector 105 at volume V2, and sets the volume of the audio that has not been selected by selector 105 at volume V1 (for example, 0) lower than volume V2 (step S123).

Then, volume controller 106 generates an output audio signal by synthesizing a plurality of audio signals after the volume control, and outputs the output audio signal to audio output unit 107.

The above-mentioned processing is the initial volume setting processing.

Using FIG. 6 again, processes after step S103 are described.

After step S103, display synthesizer 117 scrolls the display video in the preset direction (for example, from the right to the left of screen 201), and updates the display position of the display video (step S104).

Next, selector 105 determines whether the moving image whose audio is being output is no longer included in audio output region 203, on the basis of the processing executed in step S104 (namely, updating the display position of the moving image in the display video) (step S105). The determination in S105 is performed on the basis of whether the left end of the moving image is included in audio output region 203, for example. This determination criterion is also used for the determination performed in step S109 described later. Here, this determination criterion is one example, and another determination criterion may be set.

If it is determined in step S105 that the moving image whose audio is being output moves out of audio output region 203 and is no longer included in audio output region 203 (Yes in step S105), selector 105 cancels the selection of the audio of the moving image, and volume controller 106 gradually decreases the volume of the moving image whose audio is being output (step S106).

Next, selector 105 determines whether a moving image (hereinafter referred to as “other moving image”) other than the moving image whose audio is being output is included in audio output region 203 (step S107).

If it is determined in step S107 that other moving image is included in audio output region 203 (Yes in step S107), selector 105 selects the audio of other moving image included in audio output region 203. Then, volume controller 106 gradually increases the volume of the audio selected by selector 105 (step S108).

If other moving images are included in audio output region 203 in step S108, selector 105 selects the audio of the moving image that is determined to be included in audio output region 203 first, of other moving images, on the basis of the scroll direction of the display video. For example, selector 105 selects the audio of the moving image located on the leftmost side, of other moving images.

If it is determined in step S105 that the moving image whose audio is being output is included in audio output region 203 (No in step S105), if it is determined in step S107 that other moving image is not included in audio output region 203 (No in step S107), or after step S108 is performed, selector 105 determines whether a new moving image is included in audio output region 203 (step S109).

If it is determined in step S109 that a new moving image is included in audio output region 203 (Yes in step S109), selector 105 determines whether another moving image is included in audio output region 203 (step S110). In other words, selector 105 determines whether the moving image whose audio is being output is included in audio output region 203.

If it is determined in step S110 that the moving image whose audio is being output is not included in audio output region 203 (No in step S110), selector 105 selects the audio of a moving image newly included in audio output region 203. Then, volume controller 106 gradually increases the volume of the audio selected by selector 105 (step S111).

If it is determined in step S110 that the moving image whose audio is being output is included in audio output region 203 (Yes in step S110), selector 105 continues the selection of the audio of the moving image whose audio is being output included in audio output region 203. In other words, selector 105 does not select the audio of the moving image newly included in audio output region 203.

Next, controller 103 determines whether an automatic scroll operation is continued (step S112).

If it is determined in step S112 that an automatic scroll operation is continued (Yes in step S112), the processing goes back to step S104, and the processes in step S104 and after are executed.

If it is determined in step S112 that an automatic scroll operation is ended (No in step S112), video/audio processing apparatus 100 ends the processing. Video/audio processing apparatus 100 ends the processing upon receiving an operation by the user, for example.

The first exemplary embodiment has described the operation example in which the audio is faded in (the volume of the audio is gradually increased) in step S108 and step S111, and the audio is faded out (the volume of the audio is gradually decreased) in step S106. However, the present disclosure is not limited to this operation example. At least one of the fade-in in step S108 and step S111 and the fade-out in step S106 may be omitted. In this case, for example, instead of the processes in step S105 to step S111, processing similar to the initial volume setting processing in step S103 may be performed.

The first exemplary embodiment has described the operation example in which a moving image is determined to be included in audio output region 203 when the left end of the moving image is included in audio output region 203. However, the present disclosure is not limited to this operation example. This determination may be performed on the basis of the center or the right end of the moving image. Alternatively, this determination may be performed on the basis of another determination criterion (for example, the area of the moving image).

[1-5. Effect, Etc.]

As described above, the video/audio processing apparatus of the present exemplary embodiment includes a video generator, a selector, and a volume controller. The video generator generates a video signal for display video in which a plurality of region, in each of which a moving image is displayed, automatically move in a display screen in a predetermined direction. The selector selects the audio signal of one moving image, of a plurality of the moving images, in accordance with the positions of a plurality of the moving images in the display screen. The volume controller controls the volumes of the audio signals of a plurality of the moving images so that the volume of the audio signal selected by the selector is higher than the volumes of other audio signals.

Each of video/audio processing apparatus 100 and video/audio processing apparatus 100A described later is one example of the video/audio processing apparatus. Video generator 101 is one example of the video generator. Selector 105 is one example of the selector. Volume controller 106 is one example of the volume controller. Moving image 202A, moving image 202B, and moving image 202C are one example of a plurality of the moving images. Screen 201 is one example of the display screen.

Thus, the video/audio processing apparatus of the present exemplary embodiment can select the audio signal of one moving image in the display video in which a plurality of the moving images automatically scroll, and can control the volumes of a plurality of the moving images so that the audio based on the audio signal is easily heard by the user. In other words, the video/audio processing apparatus of the present exemplary embodiment can generate an audio easily heard by the user when a plurality of the moving images are displayed in one display screen.

In the video/audio processing apparatus, the selector may select, of a plurality of the moving images, the audio signal of the moving image included in a predetermined audio output region in the display screen.

Here, audio output region 203 is one example of the audio output region.

Thus, the video/audio processing apparatus can select the audio signal of the moving image existing in a region easily recognized by the user, and can output the audio. In other words, the video/audio processing apparatus can appropriately select one audio from the audios of a plurality of the moving images, and can output the one audio.

In the video/audio processing apparatus, the selector may select the audio signal of the moving image that is included in audio output region 203 first, of a plurality of the moving images included in the audio output region.

Thus, the video/audio processing apparatus can prevent the audio of the moving image to which the user pays attention from being suddenly switched to the audio of another moving image.

Furthermore, in the video/audio processing apparatus, when the selector switches the audio signal to be selected from one audio signal to another audio signal, the volume controller may gradually decrease the volume of the deselected audio signal and may gradually increase the volume of the newly selected audio signal.

Thus, when the selector switches the audio signal to be selected from one audio signal to another audio signal, the video/audio processing apparatus can achieve the audio switching that allows the user to more easily hear the audio.

### Another Exemplary Embodiment

Thus, the first exemplary embodiment has been described as an example of a technology disclosed in the present application. However, the disclosed technology is not limited to this exemplary embodiment, and can be also applied to exemplary embodiments having undergone modification, replacement, addition, or omission. A new exemplary embodiment may be created by combining the components described in the first exemplary embodiment.

Another exemplary embodiment is described hereinafter.

### Modified Example 1

In accordance with the scroll speed of a moving image in display video, volume controller 106 of video/audio processing apparatus 100 may change the period required for fade-out of an audio (period in which the volume of the audio is gradually decreased from volume V2 to volume V1) or the period required for fade-in (period in which the volume of the audio is gradually increased from volume V1 to volume V2). In other words, volume controller 106 may change the amount of variation in audio per unit time during the fade-out or fade-in of the audio in accordance with the scroll speed of the moving image in the display video. In modified example 1, video/audio processing apparatus 100 configured to perform such an operation is described.

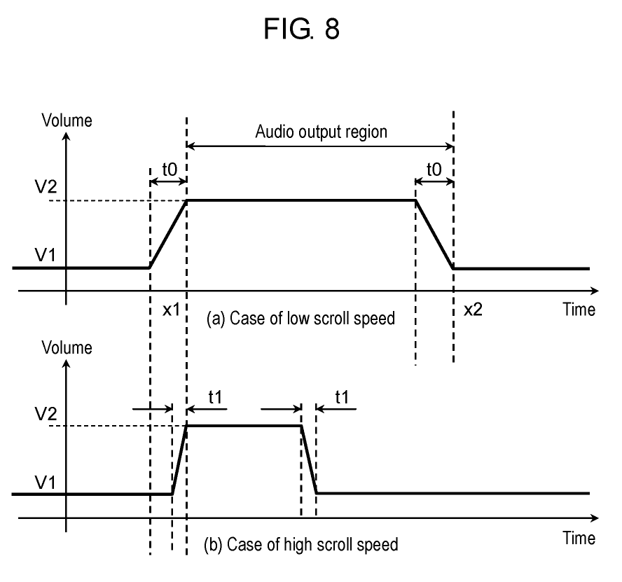

FIG. 8 is a diagram schematically showing one example of the time variation in the volume of a moving image in audio output region 203 in accordance with modified example 1 of another exemplary embodiment. FIG. 8 (a) shows the time variation in the volume when the scroll speed of the moving image is relatively low, and FIG. 8 (b) shows the time variation in the volume when the scroll speed of the moving image is relatively high.

As showing the example in FIG. 8, volume controller 106 may set period t0 required for the fade-out or fade-in of the audio when the scroll speed of the moving image is relatively low to be longer than period t1 required for the fade-out or fade-in of the audio when the scroll speed of the moving image is relatively high.

Thus, when the selector switches the audio signal to be selected from one audio signal to another audio signal, the volume controller may change the period required for varying the volume of the audio signal in accordance with the moving speed of a plurality of the moving images in the display screen.

In other words, the volume controller may have the following configuration:
in the process of switching the audio to be selected by the selector, as the scroll speed of the moving images in the display video increases, the volume controller shortens the period required for gradually decreasing the volume of the deselected audio and the period required for gradually increasing the volume of the newly selected audio.

In the video/audio processing apparatus including the volume controller having such a configuration, the fade-out or fade-in of audio can be appropriately performed in accordance with the scroll speed.

Furthermore, volume controller 106 may set the period required for the fade-out or fade-in of audio to be different between the following two cases:
selector 105 selects a new audio in the state where the audio of any moving image is not selected; and
selector 105 changes the selected audio.
   For example, volume controller 106 may set the period required for the fade-out or fade-in of the audio when selector 105 changes the selected audio to be shorter than the period required for the fade-out or fade-in of the audio when selector 105 selects a new audio in the state that the audio of any moving image is not selected. Volume controller 106 having such a configuration can continuously change the audio when selector 105 changes the selected audio.

### Modified Example 2

The first exemplary embodiment has described the following operation example:
when a plurality of the moving images is included in audio output region 203, selector 105 and volume controller 106 select, of a plurality of the moving images, the audio of the moving image that is included in audio output region 203 ahead, and output the selected audio.
   However, the present disclosure is not limited to this configuration. For example, selector 105 and volume controller 106 may be configured to, when a plurality of the moving images is included in audio output region 203, select the audio of the moving image that is included in audio output region 203 later and output the selected audio.

In other words, when a plurality of the moving images is included in audio output region 203, selector 105 may select, of a plurality of the moving images, the audio signal of the moving image that is included in audio output region 203 latest. In other words, selector 105 may be configured to, when a new moving image is included in audio output region 203, select the audio signal of the new moving image.

In modified example 2, video/audio processing apparatus 100 configured to perform such an operation is described.

Hereinafter, the operation example when two moving images 202A and 202B are included in audio output region 203 is described. In the following operation example, volume V1 is set at 0. Also when three or more moving images are included in audio output region 203, processing similar to that in the following description can be employed. Volume V1 is not limited to 0.

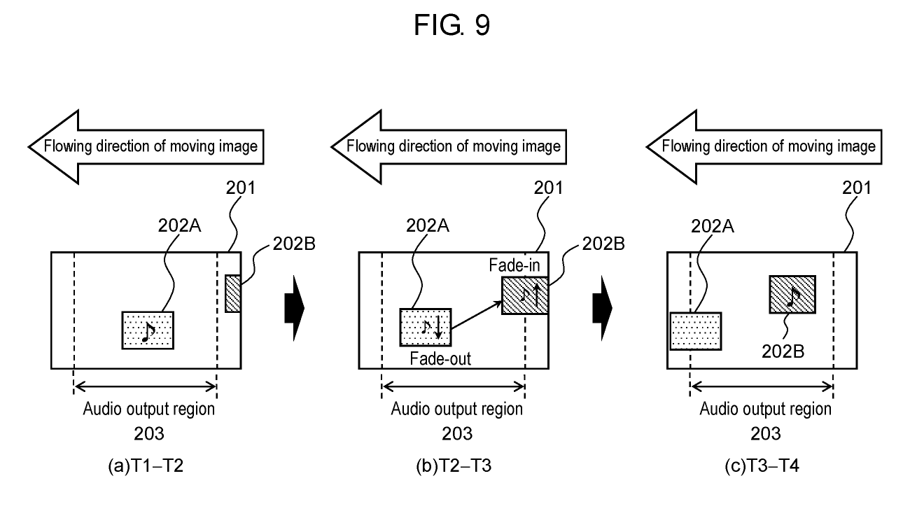

FIG. 9 is a diagram schematically showing one example of the operation of video/audio processing apparatus 100 when two moving images (image 202A and image 202B) are included in audio output region 203 in accordance with modified example 2 of another exemplary embodiment. FIG. 9 schematically shows display audio of screen 201, and the display audio changes in the sequence of (a), (b), and (c) as time passes. In FIG. 9, the scroll direction of the moving images is shown by a hollow arrow. FIG. 9 shows the following operation example:
first, moving image 202A is included in audio output region 203;
moving image 202B (left end of moving image 202B) is included in audio output region 203 before moving image 202A (left end of moving image 202A) moves out of audio output region 203; and
then, moving image 202A (left end of moving image 202A) moves out of audio output region 203 and is no longer included in audio output region 203.
   Here, the hollow arrow indicating the scroll direction of FIG. 9 is shown for convenience, and is not displayed on screen 201.

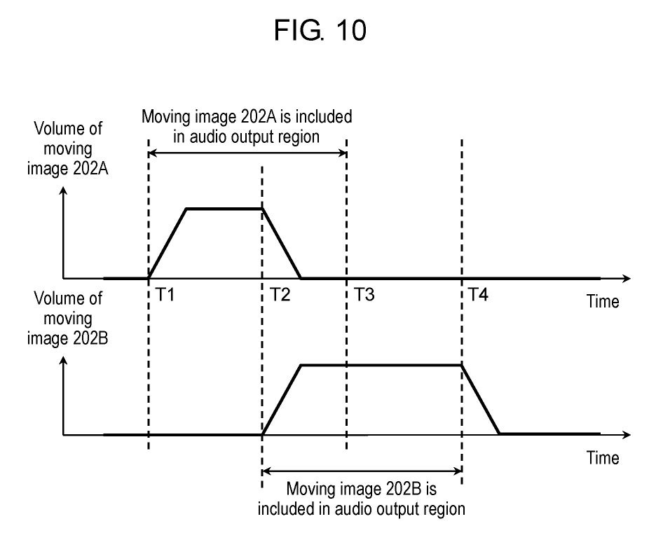

FIG. 10 is a diagram schematically showing one example of the time variation in the volume of each moving image when two moving images (image 202A and image 202B) are included in audio output region 203 in accordance with modified example 2 of another exemplary embodiment.

First, FIG. 9 (a) shows the state in the period from time T1 to time T2 of FIG. 10. In FIG. 9 and FIG. 10, the following states are assumed:
at time T1, moving image 202A (left end of moving image 202A) is included in audio output region 203;
at time T2, moving image 202B (left end of moving image 202B) is included in audio output region 203; and
at time T3, moving image 202A (left end of moving image 202A) moves out of audio output region 203 and is no longer included in audio output region 203.
   Therefore, in the period from time T1 to time T2, moving image 202A is included in audio output region 203, and moving image 202B exists outside audio output region 203 and is not included in audio output region 203. In this case, video/audio processing apparatus 100 outputs the audio of moving image 202A.

Next, FIG. 9 (b) shows the state in the period from time T2 to time T3 of FIG. 10. In the period from time T2 to time T3, moving image 202A is included in audio output region 203, but, at time T2, moving image 202B (left end of moving image 202B) moves from the outside of audio output region 203 to the inside thereof and is included in audio output region 203. Therefore, video/audio processing apparatus 100 switches the moving image whose audio is to be output from moving image 202A to moving image 202B. At this time, volume controller 106 of video/audio processing apparatus 100 gradually decreases (fades out) the audio of moving image 202A, and gradually increases (fades in) the audio of moving image 202B.

Next, FIG. 9 (c) shows the state after time T3 of FIG. 10. In the period from time T3 to time T4, moving image 202B is included in audio output region 203, so that video/audio processing apparatus 100 continuously outputs the audio of moving image 202B.

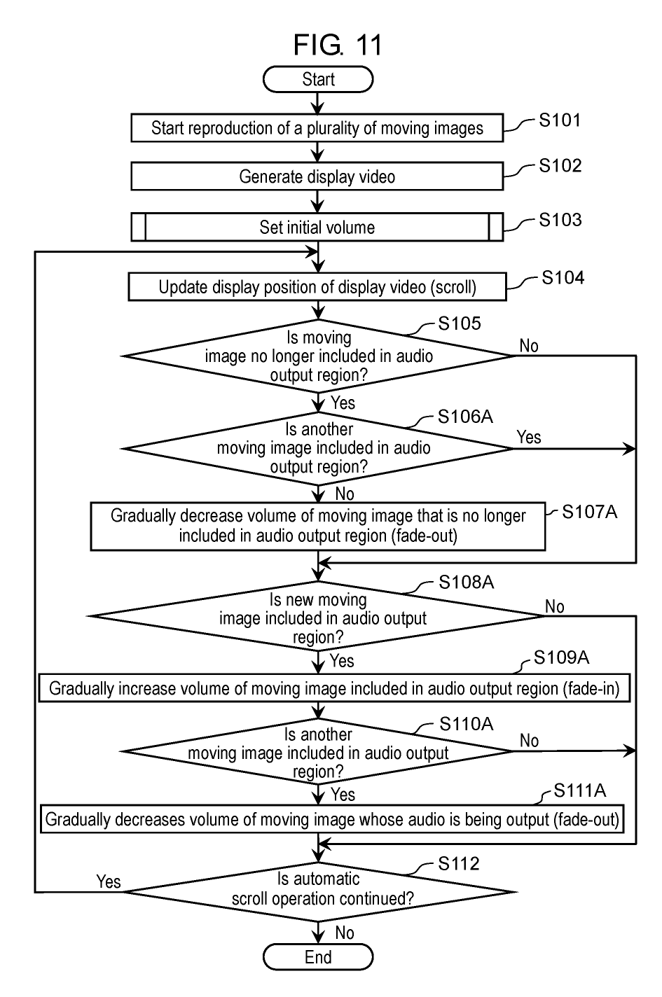

FIG. 11 is a flowchart showing one example of the video/audio generation processing executed by video/audio processing apparatus 100 in accordance with modified example 2 of another exemplary embodiment. In the flowchart of FIG. 11, processes in step S101 to step S105 and step S112 are substantially the same as the processes in the same steps of the flowchart of FIG. 6, so that the descriptions of the processes are omitted.

In step S105 of the flowchart of FIG. 6, the processing of determining whether the moving image whose audio is being output moves out of audio output region 203 and is no longer included in audio output region 203 is described. However, in step S105 of the flowchart of FIG. 11, it is simply determined whether a moving image moves out of audio output region 203 and is no longer included in audio output region 203, regardless of whether the audio of the moving image is being output. Similarly to the first exemplary embodiment, this determination is performed on the basis of whether the left end of the moving image is included in audio output region 203, for example. This determination is performed also in the following other modified examples. However, the present disclosure is not limited to this operation example. For example, this determination may be performed on the basis of the center or the right end of the moving image. Alternatively, this determination may be performed on the basis of another determination criterion (for example, the area of the moving image).

If it is determined in step S105 that the moving image moves out of audio output region 203 and is no longer included in audio output region 203 (Yes in step S105), selector 105 determines whether another moving image is included in audio output region 203 (step S106A).

If it is determined in step S106A that another moving image is not included in audio output region 203 (No in step S106A), the moving image that is determined in step S105 to move out of audio output region 203 and be no longer included in audio output region 203 is the moving image whose audio is being output. Therefore, selector 105 cancels the audio selection of the moving image that moves out of audio output region 203 and is no longer included in audio output region 203. Volume controller 106 gradually decreases the volume of the audio whose selection is canceled by selector 105 (step S107A).

In the flowchart of FIG. 11, if it is determined in step S106A that another moving image is included in audio output region 203 (Yes in step S106A), the moving image that is determined in step S105 to move out of audio output region 203 and be no longer included in audio output region 203 is not the moving image whose audio is being output. Therefore, selector 105 and volume controller 106 continue the present state without changing the selected audio (without changing the audio selection).

If it is determined in step S105 that the moving image does not move out of audio output region 203 (No in step S105), if it is determined in step S106A that another moving image is included in audio output region 203 (Yes in step S106A), or after step S107A is performed, selector 105 determines whether a new moving image is included in audio output region 203 (step S108A).

If it is determined in step S108A that a new moving image is included in audio output region 203 (Yes in step S108A), selector 105 selects the audio of the moving image newly included in audio output region 203. Volume controller 106 gradually increases the volume of the audio newly selected by selector 105 (step S109A).

Next, selector 105 determines whether a moving image (another moving image) other than the moving image newly included in audio output region 203 is included in audio output region 203 (step S110A).

If it is determined in step S110A that another moving image is included in audio output region 203 (Yes in step S110A), in addition to the moving image newly included in audio output region 203, the moving image whose audio is being output exists in audio output region 203. Therefore, selector 105 cancels the audio selection of the moving image whose audio is being output, except the moving image newly included in audio output region 203. Then, volume controller 106 gradually decreases the volume of the audio whose selection is canceled by selector 105 (step S111A).

Thus, the selector may select the audio signal of the moving image included in the audio output region latest, of a plurality of the moving images included in the audio output region.

The video/audio processing apparatus having such a configuration can always output the audio of the moving image newly included in the audio output region.

### Modified Example 3

In modified example 3, the operation of video/audio processing apparatus 100 when the distance between a plurality of scrolling moving images is relatively short is described.

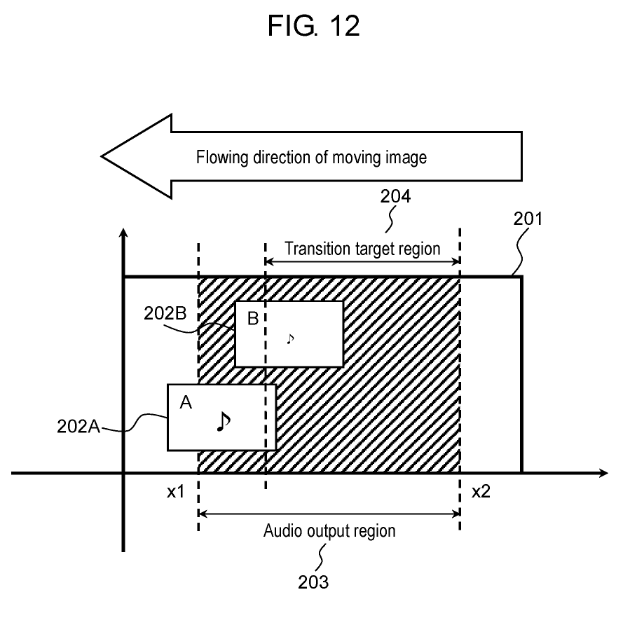

When the moving image corresponding to the audio signal selected by selector 105 moves out of audio output region 203 and is no longer included in audio output region 203, selector 105 may exclude, from the target of the next selection, the audio signal of the moving image that is no longer included in transition target region 204 (FIG. 12) set in audio output region 203.

Hereinafter, the operation example when two moving images 202A and 202B are included in audio output region 203 is described. Also when three or more moving images are included in audio output region 203, processing similar to that in the following description can be employed.

FIG. 12 is a diagram schematically showing the summary of the audio control processing in accordance with modified example 3 of another exemplary embodiment.

As showing the example in FIG. 12, when the distance from moving image 202A to moving image 202B is relatively short, immediately after the audio to be selected by selector 105 is switched from the audio of moving image 202A to the audio of moving image 202B, moving image 202B moves out of audio output region 203. Therefore, the period in which the audio of moving image 202B is output is relatively short.

In order to prevent such a state from occurring, as shown in the example in FIG. 12, transition target region 204 may be disposed in audio output region 203 on the basis of the scroll direction of the moving images. In the present modified example, the region in audio output region 203 that does not include a region on the outlet side of the scrolling moving images is set as transition target region 204. In the example in FIG. 12, a right-side region in audio output region 203 is set as transition target region 204.

Transition target region 204 is a region defined as below. In other words, if moving image 202B is included in transition target region 204 when moving image 202A moves out of audio output region 203 and is no longer included in audio output region 203, selector 105 selects the audio of moving image 202B. If moving image 202B is not included in transition target region 204, however, selector 105 does not select the audio of moving image 202B.

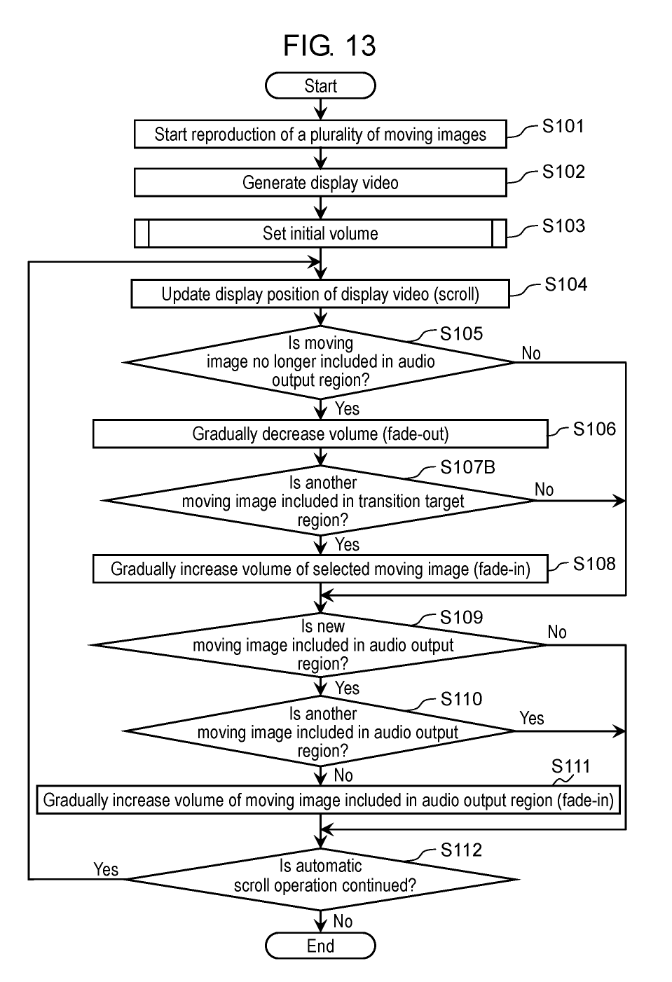

FIG. 13 is a flowchart showing one example of the video/audio generation processing executed by video/audio processing apparatus 100 in accordance with modified example 3 of another exemplary embodiment. The processes shown in the flowchart of FIG. 13 differ from each of the processes in the flowchart of FIG. 6 in that step S107 is replaced with step S107B. However, both flowcharts are substantially the same except for this point, so that detailed descriptions are omitted and only the process in step S107B is described.

Selector 105 determines whether a moving image other than the moving image whose audio is being output is included in transition target region 204 (step S107B).

If it is determined in step S107B that a moving image other than the moving image whose audio is being output is included in transition target region 204 (Yes in step S107B), step S108 similar to step S108 shown in the flowchart of FIG. 6 is executed.

If it is determined in step S107B that a moving image other than the moving image whose audio is being output is not included in transition target region 204 (No in step S107B), step S109 similar to step S109 shown in the flowchart of FIG. 6 is executed.

Thus, selector 105 may execute the following operation. For example, the case is assumed in which two moving images are included in audio output region 203 and one moving image (that is included in audio output region 203 ahead) of the two moving images moves out of audio output region 203. In this case, if the other moving image (that is included in audio output region 203 later) is included in transition target region 204, selector 105 selects the audio of the other moving image. If the other moving image is not included in transition target region 204, selector 105 does not select the audio of the other moving image. This operation can translate into the following expression. In the case that two moving images are included in audio output region 203, if, within a predetermined period after one of the moving images moves out of audio output region 203, the other moving image moves out of audio output region 203, the other moving image is not selected.

Thus, when the moving image corresponding to the audio signal selected by the selector moves out of audio output region 203 and is no longer included in audio output region 203, the selector may exclude, from the target of the next selection, the moving image that is not included in the transition target region set in the audio output region.

Transition target region 204 is one example of the transition target region.

The video/audio processing apparatus having such a configuration can prevent the phenomenon in which, when the distance between a plurality of scrolling moving images is relatively short, the audio of a moving image included in the audio output region later is output for a short time.

### Modified Example 4

The first exemplary embodiment does not especially handle the display of the volume, but the video generator may generate the icon indicating the volume of the audio signal selected by the selector.

For example, on the moving images scrolling in the display screen, icons indicating the volumes of the moving images may be overlaid and displayed, respectively.

In modified example 4, video/audio processing apparatus 100A configured to display the moving images scrolling in the display screen in the state that icons indicating the volumes of the moving images are respectively overlaid on the moving images is described.

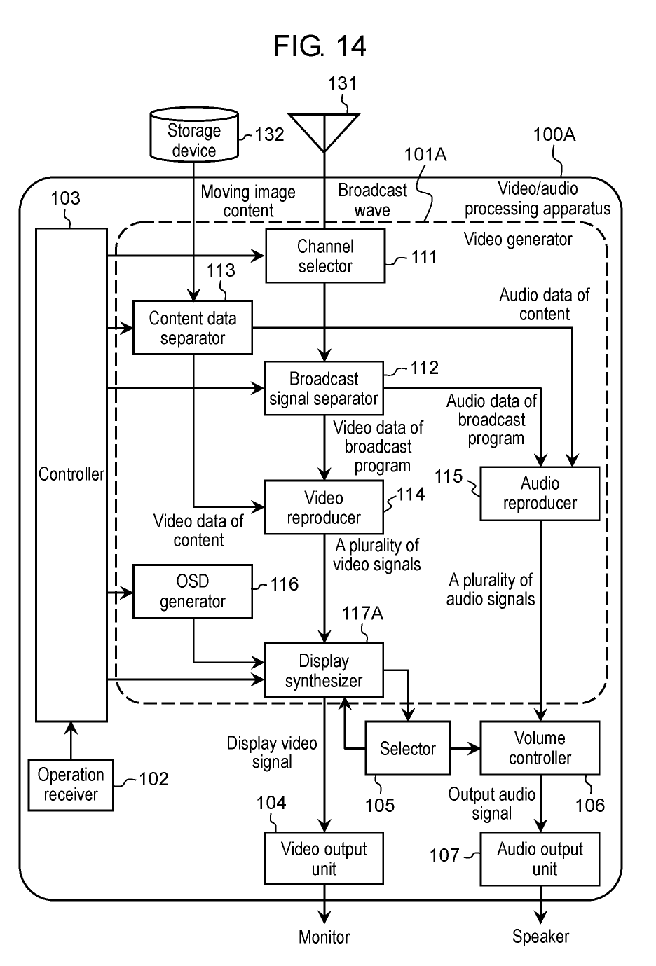

FIG. 14 is a block diagram showing one configuration example of video/audio processing apparatus 100A in accordance with modified example 4 of another exemplary embodiment.

Video/audio processing apparatus 100A includes video generator 101A, operation receiver 102, controller 103, video output unit 104, selector 105, volume controller 106, and audio output unit 107.

Video generator 101A includes channel selector 111, broadcast signal separator 112, content data separator 113, video reproducer 114, audio reproducer 115, OSD generator 116, and display synthesizer 117A.

By comparison of video/audio processing apparatus 100A of FIG. 14 with video/audio processing apparatus 100 of FIG. 1, the function of display synthesizer 117A of video generator 101A is different from that of display synthesizer 117 of video generator 101. However, both apparatuses are substantially the same except for this point, so that detailed descriptions are omitted and only display synthesizer 117A is described.

Display synthesizer 117A of video/audio processing apparatus 100A shown in FIG. 14 has not only the function included in display synthesizer 117 of video/audio processing apparatus 100 shown in FIG. 1, but also the function of generating icons indicating the volumes of the moving images scrolling in the display screen and overlaying and displaying them on the moving images.

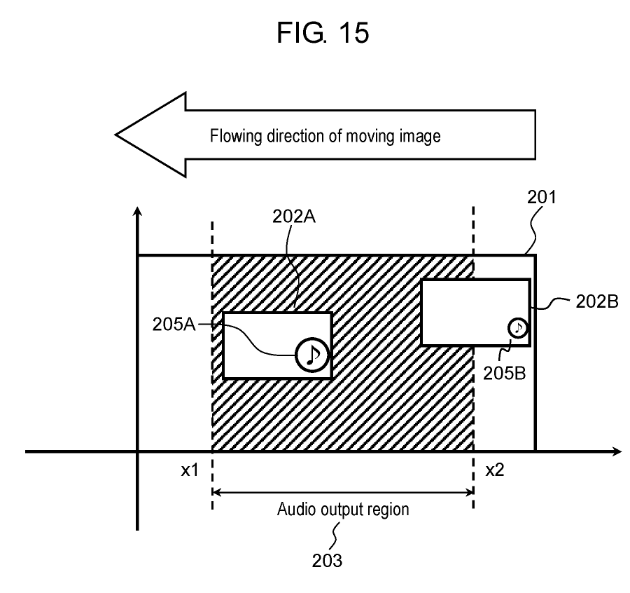

One example of the icons indicating the volumes of the moving images generated by display synthesizer 117A is shown in FIG. 15.

FIG. 15 is a diagram schematically showing one example of display video in accordance with modified example 4 of another exemplary embodiment.

In the example in FIG. 15, display synthesizer 117A generates icon 205A as an icon indicating the volume of moving image 202A, and generates icon 205B as an icon indicating the volume of moving image 202B. Display synthesizer 117A overlays icon 205A on moving image 202A, overlays icon 205B on moving image 202B, and synthesizes them to generate a display video signal.

Therefore, moving image 202A on which icon 205A is overlaid and moving image 202B on which icon 205B is overlaid are individually displayed on screen 201, and the moving images scroll from the right to the left in screen 201.

In the example shown in FIG. 15, display synthesizer 117A generates an icon having the size corresponding to the level of the volume. In other words, display synthesizer 117A generates a relatively large icon for a moving image having a relatively high volume and overlays it on the moving image, or generates a relatively small icon for a moving image having a relatively low volume and overlays it on the moving image. Therefore, in the example in FIG. 15, by comparing icon 205A and icon 205B displayed on screen 201 with each other, the user can easily understand that the presently output audio is the audio of moving image 202A.

The present disclosure is not limited to the operation example shown in FIG. 15. For example, display synthesizer 117A generates an icon indicating the volume only for the audio selected by selector 105, and does not need to generate an icon indicating the volume for the audio that is not selected by selector 105. In the example shown in FIG. 15, display synthesizer 117A displays only icon 205A of moving image 202A on screen 201, and does not need to display icon 205B of moving image 202B on screen 201. In this case, the user can easily understand that the presently output audio is the audio of moving image 202A by looking at icon 205A displayed on screen 201.

Display synthesizer 117A may express the level of the volume as not the size of an icon but the color of the icon.

Furthermore, during the fade-in of an audio or the fade-out of an audio, display synthesizer 117A may change the design of the icon in conjunction with the effect of the fade-in or fade-out.

Furthermore, display synthesizer 117A may display an icon indicating the level of the volume not on the moving image but around the moving image so that the moving image is not hidden by the icon.

Thus, the video generator may generate an icon indicating the volume of the audio signal selected by the selector. Thus, the user can visually recognize the volume of the moving image scrolling on the display screen.

Thus, as an example of the technology of the present disclosure, the exemplary embodiment is described. For that purpose, accompanying drawings and detailed descriptions are provided.

Therefore, components written in the accompanying drawings and detailed descriptions can include not only components essential for solving problems, but also components that are used for exemplifying the technology and are not essential for solving problems. Therefore, just because the nonessential components are written in the accompanying drawings and detailed descriptions, the nonessential components should not be determined to be essential.

Since the above-mentioned exemplary embodiments are used for exemplifying the technology of the present disclosure, various modifications, replacements, additions, or omissions can be performed in the scope of the claims or its equivalent scope.

For example, these general or specific aspects may be achieved by an apparatus, a system, a method, an integrated circuit, a computer program, or a recording medium such as a computer-readable compact-disk read-only-memory (CD-ROM), or may be achieved by any combination of the system, the method, the integrated circuit, the computer program, and the recording medium.

In the exemplary embodiments described above, each component may be formed of dedicated hardware or may be achieved by executing a software program appropriate for each component. Each component may be achieved by the operation in which a program executor such as a central processing unit (CPU) or processor reads and executes a software program recorded in a recording medium such as a hard disk or semiconductor memory.

All of the numerical values used above are examples for specifically describing the present disclosure. The present disclosure is not limited to the exemplified numerical values.

The division of function blocks in a block diagram is one example. A plurality of function blocks may be achieved as one function block, one function block may be divided into a plurality of function blocks, or some functions may be transferred to other functions. Furthermore, regarding a plurality of function blocks having similar functions, the similar functions may be processed in parallel or in a time division by single hardware or software.

The executing sequence of a plurality of the steps shown in the above-mentioned flowchart is an example for specifically describing the present disclosure. A sequence other than the above-mentioned sequence may be employed. Some of the steps described above may be executed simultaneously (in parallel) with other steps

### INDUSTRIAL APPLICABILITY

The present disclosure is applicable to a video/audio processing apparatus. Specifically, the present disclosure is applicable to a television, a recorder, a personal computer, or a tablet terminal device.

### REFERENCE MARKS IN THE DRAWINGS

100, 100A video/audio processing apparatus
101, 101A video generator
102 operation receiver
103 controller
104 video output unit
105 selector
106 volume controller
107 audio output unit
111 channel selector
112 broadcast signal separator
113 content data separator
114 video reproducer
115 audio reproducer
116 OSD generator
117, 117A display synthesizer
131 antenna
132 storage device
201 screen
202A, 202B, 202C, A, B, C moving image
203 audio output region
204 transition target region
205A, 205B icon

1. A video/audio processing apparatus comprising:
a video generator for generating a video signal for display video in which a plurality of regions, in each of which a moving image is displayed, automatically move in a display screen in a predetermined direction;
a selector for selecting an audio signal of one moving image, of a plurality of the moving images, in accordance with positions of a plurality of the moving images in the display screen; and
a volume controller for controlling volume of each of audio signals of a plurality of the moving images so that a volume of the audio signal selected by the selector is higher than volumes of other audio signals.

2. The video/audio processing apparatus according to claim 1, wherein
the selector selects an audio signal of a moving image included in a predetermined audio output region in the display screen, of a plurality of the moving images.

3. The video/audio processing apparatus according to claim 2, wherein
the selector selects an audio signal of a moving image included in the audio output region first, of a plurality of the moving images included in the audio output region.

4. The video/audio processing apparatus according to claim 2, wherein
the selector selects an audio signal of a moving image included in the audio output region latest, of a plurality of the moving images included in the audio output region.

5. The video/audio processing apparatus according to claim 3, wherein
when a moving image corresponding to an audio signal selected by the selector moves out of the audio output region and is no longer included in the audio output region, the selector excludes, from a target of a next selection, a moving image that is not included in a transition target region set in the audio output region.

6. The video/audio processing apparatus according to claim 1, wherein
when the selector switches an audio signal to be selected from a first audio signal to a second audio signal, the volume controller gradually decreases a volume of the deselected first audio signal, and gradually increases a volume of the newly selected second audio signal.

7. The video/audio processing apparatus according to claim 6, wherein
when the selector switches an audio signal to be selected from the first audio signal to the second audio signal, the volume controller changes a period required for varying the volume of each of the first and second audio signals in accordance with a moving speed of a plurality of the moving images in the display screen.

8. The video/audio processing apparatus according to claim 1, wherein
the video generator generates an icon indicating a volume of an audio signal selected by the selector.

9. A video/audio processing method comprising:
generating a video signal for display video in which a plurality of regions, in each of which a moving image is displayed, automatically move in a display screen in a predetermined direction;
selecting an audio signal of one moving image, of a plurality of the moving images, in accordance with positions of a plurality of the moving images in the display screen; and
controlling volume of each of audio signals of a plurality of the moving images so that a volume of the selected audio signal is higher than volumes of other audio signals.

10. A non-transitory computer-readable recording medium storing a computer program for causing a computer to execute the video/audio processing method according to claim 9.
